(19) United States
(12) Patent Application Publication
(10) Pub. No.: US 2014/0292177 A1
(43) Pub. Date: Oct. 2, 2014

(54) Lateral Traverse Discharge Spark Plug

(71) Applicant: Mark Nagy, Lakewood, CA (US)

(72) Inventor: Mark Nagy, Lakewood, CA (US)

(21) Appl. No.: 13/855,131

(22) Filed: Apr. 2, 2013

(51) Int. Cl. H01T 13/20

(52) U.S. Cl. CPC H01T 13/20
USPC 313/141

(57) ABSTRACT

A lateral transverse discharge spark plug (10) which consists of a cylindrical metallic shell (20) having a tubular ceramic insulator (22), including an insulator attachment end (28) enclosed therein. An offset center electrode (30) is surrounded by the ceramic insulator. The offset center electrode has a firing tip (36) extending from the insulator distal end. A ground electrode 38 is attached to a side of the metallic shell, and the ground electrode has a first gap (#1^{GAP}) distanced from the offset center electrode. The offset center electrode and the ground electrode protrude from the cylindrical metallic shell attachment end and the end of said ceramic insulator in a terminally aligned orientation. A second embodiment utilizing a center electrode (31) is also disclosed.

### TECHNICAL FIELD

The invention generally pertains to spark plugs for internal combustion engines and more specifically, to a spark plug that creates a spark flanked on the same plane with an offset positive electrode firing tip and a negative ground electrode beveled tip.

### BACKGROUND ART

Previously, many types of multi-gap spark plugs have been used to provide an effective means for to igniting a gaseous mixture of fuel and air within an engine combustion chamber. A spark plug typically utilizes high voltage electric current to create a spark that facilitates combustion, thus generating power to drive an internal combustion engine.

A search of the prior art did not disclose any patents that possess the novelty of the instant invention; however the following U.S. patents are considered related:

| Patent Number | Inventor | Issue Date |
|---|---|---|
| 2,136,206 | Dukelow | Nov. 8, 1938 |
| 5,189,333 | Kagawa et al. | Feb. 23, 1993 |
| 6,095,124 | Matsubara et al. | Aug. 1, 2000 |
| 6,750,597 B1 | Sakura | Jun. 15, 2004 |
| 7,922,551 B2 | Tozzi | Apr. 12, 2011 |
| 8,258,686 B2 | Kanao et al. | Sep. 4, 2012 |
| 8,269,405 B1 | Wang | Sep. 18, 2012 |
| 8,334,642 B2 | Korenev | Dec. 18, 2012 |
| 8,388,396 B2 | Hill | Mar. 5, 2013 |

Dukelow in U.S. Pat. No. 2,136,206 discloses a spark plug for an internal combustion engine. The spark plug has an intermediate electrode which is insulated from both the shell and the central electrode providing two gaps resulting in an operation that is more efficient and that provide a hotter spark.

Kagawa et al. in U.S. Pat. No. 5,189,333 discloses a multi-gap spark plug having a metallic shell into which a tubular ceramic insulator is enclosed. A center electrode is enclosed in the insulator and a plurality of L-shaped outer electrodes, having a vertical piece and a lateral piece which depend from the front end of the shell surrounding the insulator. The lateral piece has an inner surface parallel with a front end of the insulator. The distance between the insulator and the outer electrode is from 0.3 mm to 1.2 mm.

U.S. Pat. No. 6,095,124 issued to Matsubara et al. discloses a spark plug having a center electrode, a ground electrode and an insulator. A discharge high voltage is applied across the center electrode and the ground electrode such that a polarity of the center electrode is positive and that of the ground electrode is negative. The high voltage causes a spark discharge to be generated between the firing surface of the ground electrode and a tip end portion of the center electrode.

Sakura in U.S. Pat. No. 6,750,597 discloses a method of manufacturing a spark plug having a center electrode, an insulator disposed around its center, and a ground electrode in opposition to the center electrodes to form, a spark discharge gap therebetween. A high melting point metal is welded to at least the free end portion of the ground electrode.

U.S. Pat. No. 7,922,551 of Tozzi discloses a method and apparatus to maximize spark plug life and reduce electrode erosion by spreading discharge energy over a wide surface area while maintaining safe electrode temperature. Energy is spread with a swirling effect created by a periphery hole in an end cap. The flow field generated at the electrodes prevent electrical shorts due to water condensation and provides an effective heat transfer path.

Kanao et al. in U.S. Pat. No. 8,258,686 discloses a spark plug which includes a tubular metal shell, an insulator, a cylindrical center electrode and a ground electrode. The ground electrode has an inclined portion, and a strait portion with a bend therebetween. The inclined portion extends obliquely with respect to the axial direction of the center electrode providing a base end of the ground electrode. The straight portion of the center electrode extends substantially parallel to the axial direction of the center electrode from the bend to a tip end of the ground electrode.

Wang in U.S. Pat. No. 8,269,405 discloses a neutral electrode spark plug consisting of a cylindrical metallic shell having a tubular ceramic insulator, an insulator tip enclosed therein, and a central electrode surrounded by the ceramic insulator. The central electrode has a firing tip extending from the insulator tip. A neutral electrode extends from the insulator tip providing a first spark gap that is separated from the central electrode. A side ground electrode is attached to the metallic shell and is laterally aligned with the central electrode and the neutral electrode. The ground electrode provides a second spark gap that is separated from the neutral insulator and a third spark gap formed with the ground electrode.

Hill in U.S. Pat. No. 8,388,396 discloses a spark plug using a space between an electrode body and an electrode cage. The electrode cage extends over the electrode body such that the actuate members of the cage are equidistantly spaced from the spherical electrode body.

### DISCLOSURE OF THE INVENTION

The spark plug was known as early as 1860 and patented in the United States by Nikola Tesla in 1898. Since then there have been substantial improvements to spark plug design in an attempt to provide either better ignition, longer life, or both. Such improvements include the use of two or three ground electrodes surrounding a central electrode. Recessed central electrodes have also been developed utilizing single notches in the tip of the ground or central electrodes have been used in an attempt to provide a longer useful life when the spark gap widens during electrical discharge wear permitting the spark to move closer to another spot when a current of electrons surge across the gap. In most cases a conventional spark plug utilizes a vertical spark gap between the center electrode and the ground electrode or neutral.

The primary object of the invention is to provide an improved spark plug by providing a lateral or cross fire spark path utilizing sharp edges in the electrodes which have been known to decrease demand voltage across the spark gap and to also provide a more constant and stable ignition. A ground or neutral electrode is angled into the offset or center electrode on the same plane, providing sharp edges for the spark gap.

The positioning of the cross fire allows the spark kernel to develop considerably deeper into the cylinder bore, thereby resulting in a cleaner and more powerful ignition of the fuel and air mixture.

An important object of the invention is the inclusion of a beveled ground electrode which produces a distinct sharp edge between the beveled end and the firing tip of the center electrode.

Another important object of the invention is that the length and position of the electrodes is easily accomplished in the basic design as it requires only a small modification to the components and positioning tooling. The manufacturing process is therefore not fundamentally affected, thus allowing the improvement to be realized by the end user with little or no extra expense.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a front view of the lateral traverse discharge spark plug in the preferred embodiment, with one side cut away on the centerline to illustrate the internal composition.

FIG. 2 is a bottom view of the lateral traverse discharge spark plug in the preferred embodiment.

FIG. 3 is an enlarged view of the lower portion of the lateral traverse discharge spark plug in the preferred embodiment.

FIG. 4 is an enlarged view of the lower portion of the lateral traverse discharge spark plug in the second embodiment.

### BEST MODE FOR CARRYING OUT THE INVENTION

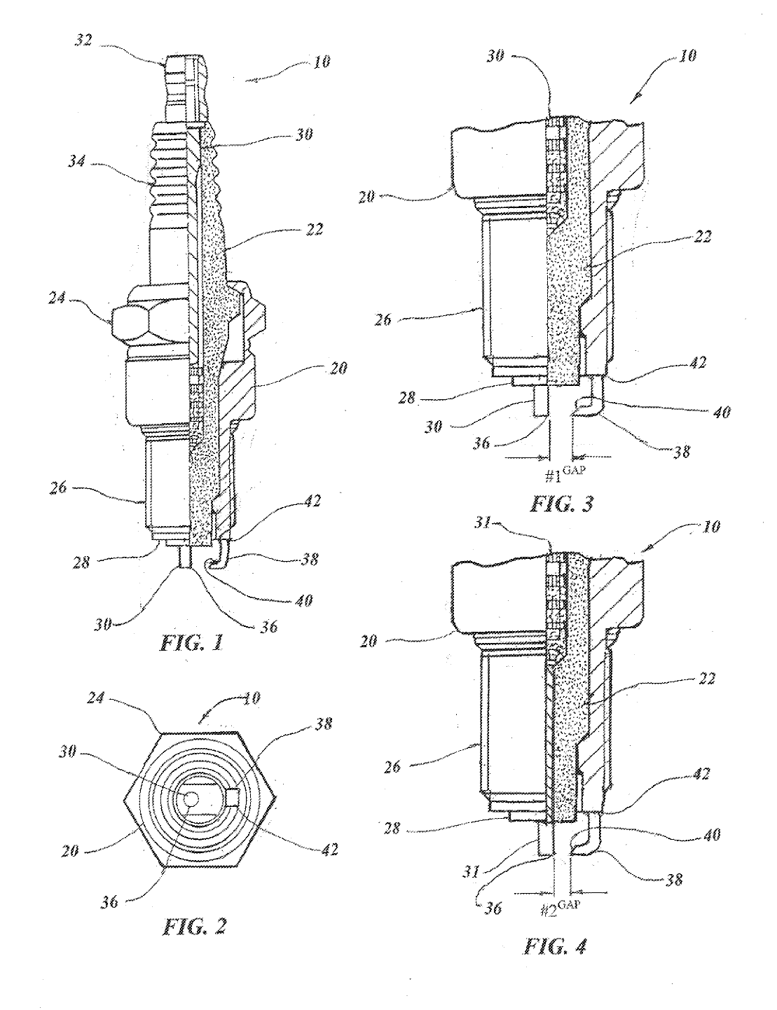

The best mode for carrying out the invention is presented in terms that disclose a preferred and a second embodiment of a lateral traverse discharge spark plug for an internal combustion engine. The preferred embodiment of the lateral traverse discharge spark plug 10, as shown in FIGS. 1 through 3, is comprised of a cylindrical metallic shell 20 having a tubular ceramic insulator 22 enclosed within. The metallic shell 20 includes a hexagonal portion 24 having a configuration suitable for receiving a wrench socket. A lower threaded portion 26 is formed around the ceramic insulator 22 for attachment of the spark plug 10 to a cylinder block of an internal combustion engine.

The ceramic insulator 22 is essentially tubular in shape with a cylindrical shaped bottom portion converging into an attachment end 28 that extends from the metallic shell 20 from 0.10 inches (0.254 mm) to 0.20 inches (0.508 mm), as illustrated in FIGS. 1 and 3. The basic purpose of the insulator 22 is to provide insulation from high voltage. The secondary role, particularly in modern engines with deeply recessed plugs, is to extend the spark plug 10 above the cylinder head to make it more accessible, including its terminal 32 which is attached to the top of the offset center electrode 30. Ribs 34 in the ceramic insulator 22 are provided in an exposed top portion to promote electrical isolation and prevent electrical energy from leaking along the insulator surface from the terminal 32 to the metallic shell 20.

The offset center electrode 30 is surrounded by the ceramic insulator 22 within the metallic shell 20. The offset center electrode 30 terminates with a firing tip 36 that extends from the attachment end 28 of the ceramic insulator 22. The center electrode 30 is offset, as illustrated in FIGS. 1 and 3, and continues from an imaginary centerline in the opposite direction, which is aligned away from a ground electrode 38.

The offset center electrode 30 has a diameter on a firing tip end 36 preferably ranges from 0.09 inches (0.229 mm) to 0.10 inches (0.254 mm) extending from the insulator 28. The diameter of the central electrode 30 permits the electrons to be emitted where the electrical field strength is greatest, particularly where the area is the smallest and a sharp edge is provided. The offset center electrode integral circular-shaped peripheral firing tip 36 is illustrated in FIGS. 1-3.

The ground electrode 38, as shown best in FIGS. 1 and 3, extends from the cylindrical metallic shell 20 creating a first spark gap #1^{GAP} at a distance from the offset center electrode 30, preferably of at least 0.010 inches (0.245 mm). The ground electrode 38 includes a right angle bend, with its distal end having a beveled tip 40, as depicted best in FIGS. 1 and 3. The ground electrode 38 has a width ranging from 0.12 inches (3.0 mm) to 0.15 inches (3.8 mm) and is attached to the metallic shell 20 with a weld bead 42 surrounding the entire electrode, as depicted in FIG. 2. The weld bead 42 may be either welded by conventional methods or hot forged.

The offset center electrode 30 and the ground electrode 38 protrude from the cylindrical metallic shell 20 attachment end 28 of the end of the ceramic insulator 22 in a terminally aligned orientation with the offset center electrode 30. The ground electrode 38 is spaced from the firing tip 36 and the beveled tip 40 no less than double the diameter of the firing tip 36.

The spark plug metallic shell 20 and ground electrode 38 are preferably plated with chromium, however other plating materials may also be used for corrosion protection.

The second embodiment, as illustrated in FIG. 4, is the same as the preferred embodiment, depicted in FIGS. 1-3, except the offset center electrode 30 is replaced by a center electrode. This center electrode 31 preferably has a external end diameter ranging from 0.09 inches (0.229 mm) to 0.10 inches (0.254 mm) extending from the ceramic insulator 22. The center electrode 31 has the same integral circular shaped peripheral firing tip 35 as the offset center electrode 30. The ground electrode 38 has the same right angle bend, with a distal end having the beveled tip 40. Similarly the center electrode 31 and the ground electrode 38 extend from the firing tip 36 and the beveled tip 40 no less than double the diameter of the firing tip 36. Thus a second gap #2^{GAP} is defined as a distance between the center electrode 31 and the ground electrode 38 which is preferably at least 0.020 inches (0.05 mm).

While the invention has been described in detail and pictorially shown in the accompanying drawings, it is not to be limited to such details, since many changes and modifications may be made to the invention without departing from the spirit and scope thereof. Hence, it is described to cover any and all modifications and forms which may come within the language and scope of the appended claims.

1. A lateral traverse discharge spark plug for an internal combustion engine, wherein said spark plug comprises:
a) a cylindrical metallic shell having a ceramic insulator enclosed therein,
b) an offset center electrode surrounded by said ceramic insulator,
c) a ground electrode attached to the metallic shell, wherein said ground electrode having a first gap distanced from said offset center electrode, and
d) said offset center electrode and said ground electrode protruding from the cylindrical metallic shell and said ceramic insulator in a terminally aligned orientation.

2. A lateral traverse discharge spark plug for an internal combustion engine, wherein said spark plug comprises:
a) a cylindrical metallic shell having a tubular ceramic insulator enclosed therein and said metallic shell having an attachment end thereof,
b) a offset center electrode surrounded by said ceramic insulator,
c) a ground electrode attached to a side of said metallic shell, wherein said ground electrode having a first gap distanced away from said offset center electrode, and
d) said offset center electrode and said ground electrode protruding from the cylindrical metallic shell attachment end and the end of said ceramic insulator in a terminally aligned orientation.

3. The lateral traverse discharge spark plug as recited in claim 2 wherein said cylindrical metallic shell further comprises a hexagonal portion having a configuration suitable for receiving a wrench socket, and a lower threaded portion formed around said cylindrical metallic shell for attachment of said spark plug to a cylinder block of an internal combustion engine.

4. The lateral traverse discharge spark plug as recited in claim 2 wherein said tubular ceramic insulator having cylindrical shaped bottom portion extending from said metallic shell ranging from 0.10 inches (0.254 mm) to 0.20 inches (0.508 mm).

5. The lateral traverse discharge spark plug as recited in claim 2 wherein said offset center electrode has a external end diameter ranging from 0.09 inches (0.229 mm) to 0.10 inches (0.254 mm) extending from said ceramic insulator.

6. The lateral traverse discharge spark plug as recited in claim 2 wherein said offset center electrode having an integral circular shaped peripheral firing tip.

7. The lateral traverse discharge spark plug as recited in claim 2 wherein said ground electrode includes a right angle bend with a distal end having a beveled tip.

8. The lateral traverse discharge spark plug as recited in claim 7 wherein said offset center electrode and said ground electrode extend from said firing tip and said beveled tip no less than double the diameter of said firing tip.

9. The lateral traverse discharge spark plug as recited in claim 2 wherein said offset center electrode is offset from an ,imaginary centerline in the opposite direction aligned away from said ground electrode.

10. The lateral traverse discharge spark plug as recited in claim 2 wherein said ground electrode is attached to said metallic shell with a weld bead surrounding said ground electrode.

11. The lateral traverse discharge spark plug as recited in claim 2 wherein said ground electrode has a width ranging from 0.12 inches (0.30 mm) to 0.15 inches (0.38 mm).

12. The lateral traverse discharge spark plug as recited in claim 2 wherein said first gap is defined as a distance between said ground electrode and said offset center electrode and is at least 0.100 inches (0.245 mm).

13. The lateral traverse discharge spark plug as recited in claim 2 wherein said spark plug cylindrical metallic shell and said ground electrode are plated with chromium.

14. A lateral traverse discharge spark plug for an internal combustion engine wherein said spark plug comprises:
a) a cylindrical metallic shell having a tubular ceramic insulator enclosed therein and said metallic shell having an attachment end thereof,
b) a center electrode surrounded by said ceramic insulator,
c) a ground electrode attached to the metallic shell, wherein said ground electrode having a second gap a distanced away from the center electrode, and
d) said center electrode and said ground electrode protruding from the cylindrical metallic shell attachment end and the end of said ceramic insulator in a terminally aligned orientation.

15. The lateral traverse discharge spark plug as recited in claim 14 wherein said center electrode has a external end diameter ranging from 0.09 inches (0.229 mm) to 0.10 inches (0.254 mm) extending from said ceramic insulator.

16. The lateral traverse discharge spark plug as recited in claim 14 wherein said center electrode having an integral circular shaped peripheral firing tip.

17. The lateral traverse discharge spark plug as recited in claim 16 wherein said ground electrode includes a right angle bend with a distal end having a beveled tip.

18. The lateral traverse discharge spark plug as recited in claim 17 wherein said center electrode and said ground electrode extend from said firing tip and said beveled tip no less than double the diameter of said firing tip.

19. The lateral traverse discharge spark plug as recited in claim 14 wherein said second gap is defined as a distance between the center electrode and the ground electrode at least 0.020 inches (0.05 mm).
